(19) United States
(12) Patent Application Publication
(10) Pub. No.: US 2026/0030345 A1
(43) Pub. Date: Jan. 29, 2026

(54) LARGE LANGUAGE MODELING-BASED MAPPING OF COMMON VULNERABILITIES AND EXPOSURES TO MITRE ATT&CK TACTICS AND TECHNIQUES

(71) Applicant: Palo Alto Networks, Inc., Santa Clara, CA (US)

(72) Inventors: Taojie Wang, San Jose, CA (US); Jiangnan Li, Santa Clara, CA (US); Shengming Xu, San Jose, CA (US); Zhibin Zhang, Santa Clara, CA (US); Qi Deng, Sunnyvale, CA (US)

(21) Appl. No.: 18/781,764

(22) Filed: Jul. 23, 2024

(51) Int. Cl. G06F 21/55; G06F 21/57

(52) U.S. Cl. CPC G06F 21/552; G06F 21/577

(57) ABSTRACT

A plurality of Common Vulnerabilities and Exposures (CVEs) is obtained. The CVEs are pre-processed in part by extracting information from the plurality of CVEs to generate a training dataset. One or more pre-trained large language models (LLMS) are fine-tuned using a balanced version of the training dataset. A mapping of the plurality of CVEs to one or more attack tactics is automatically generated utilizing the one or more fine-tuned LLMs by inputting into the one or more fine-tuned LLMS vulnerability descriptions associated with the plurality of CVEs

### BACKGROUND OF THE INVENTION

A Common Vulnerabilities and Exposures (CVE) is a standardized identifier for a known security vulnerability in software or hardware. A CVE is associated with a corresponding identifier and a corresponding description that describes the vulnerability (e.g., vulnerability, impact, known mitigation or patch information). CVE entries are maintained in a database that organizations or individuals may utilize to find and track vulnerabilities in their systems or application.

The MITRE ATT&CK Framework is a comprehensive and detailed model for understanding the actions and behavior of cyber adversaries. The MITRE ATT&CK Framework outlines the stages of an adversary's attack lifecycle through a series of tactics, which represent the adversary's goal at different stages of an attack. Examples of tactics include, but are not limited to: initial access, execution, persistence, privilege escalation, defense evasion, credential access, discovery, lateral movement, collection, command and control, exfiltration, and impact.

The MITRE ATT&CK Framework further includes techniques for each of the tactics. A technique describes the methods or ways by which an adversary may achieve a particular tactic. For example, for a persistence tactic, a technique may include a create account technique or a power settings technique.

A CVE system may identify a security vulnerability and compute a common vulnerability scoring system (CVSS) score that indicates a severity associated with the security vulnerability. However, the CVSS score, by itself, is not sufficient to indicate the urgency with which the security vulnerability is to be resolved because the CVSS score does not indicate which stage on the MITRE ATT&CK Framework that a system or application associated with an organization or individual is currently experiencing a security vulnerability.

### BRIEF DESCRIPTION OF THE DRA WINGS

Various embodiments of the invention are disclosed in the following detailed description and the accompanying drawings.

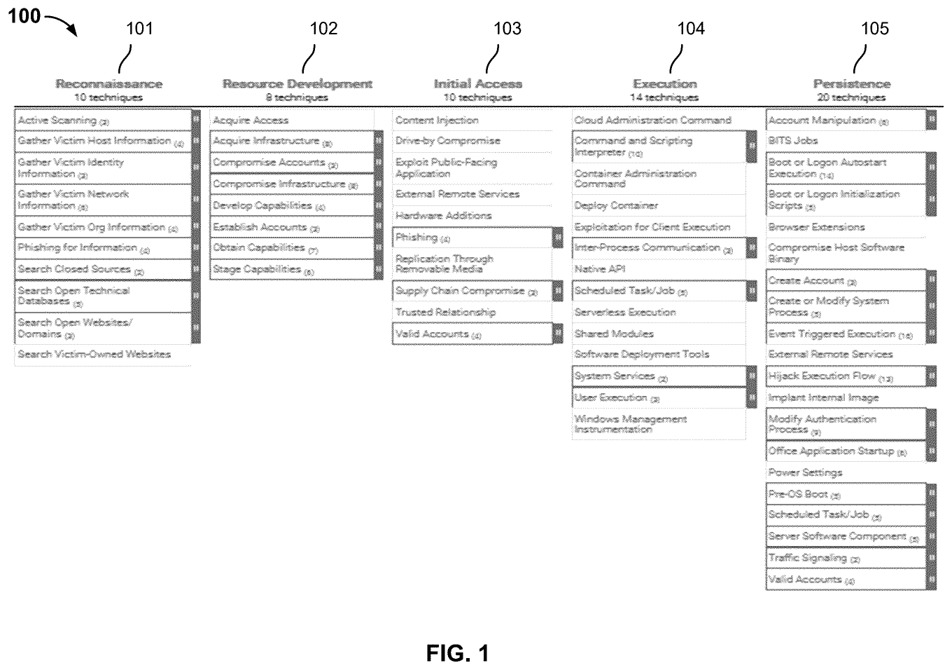

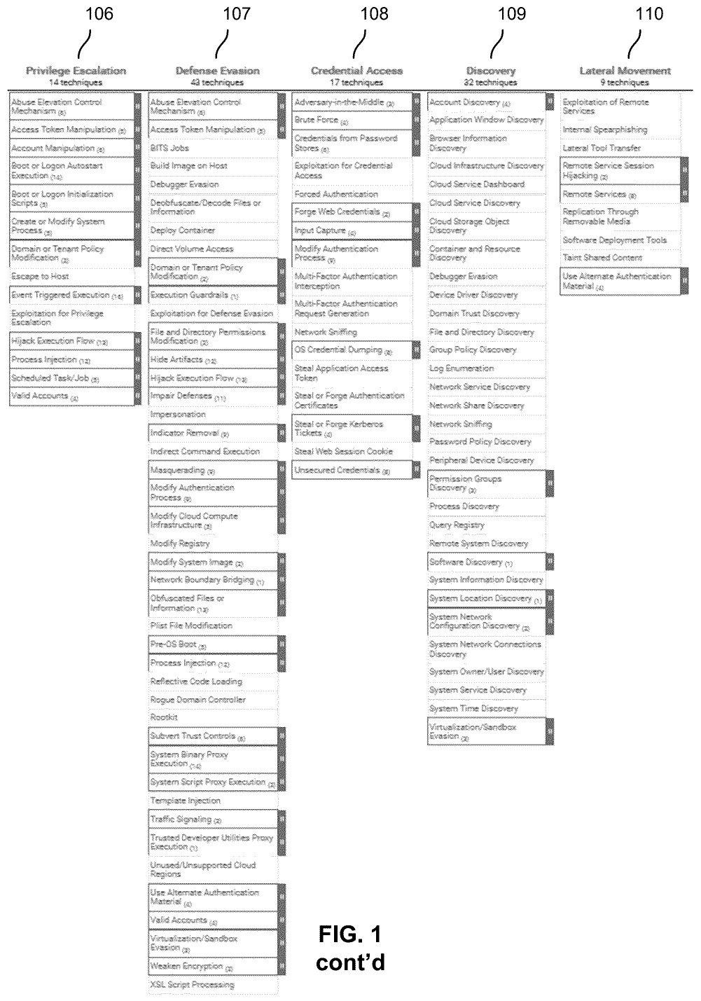

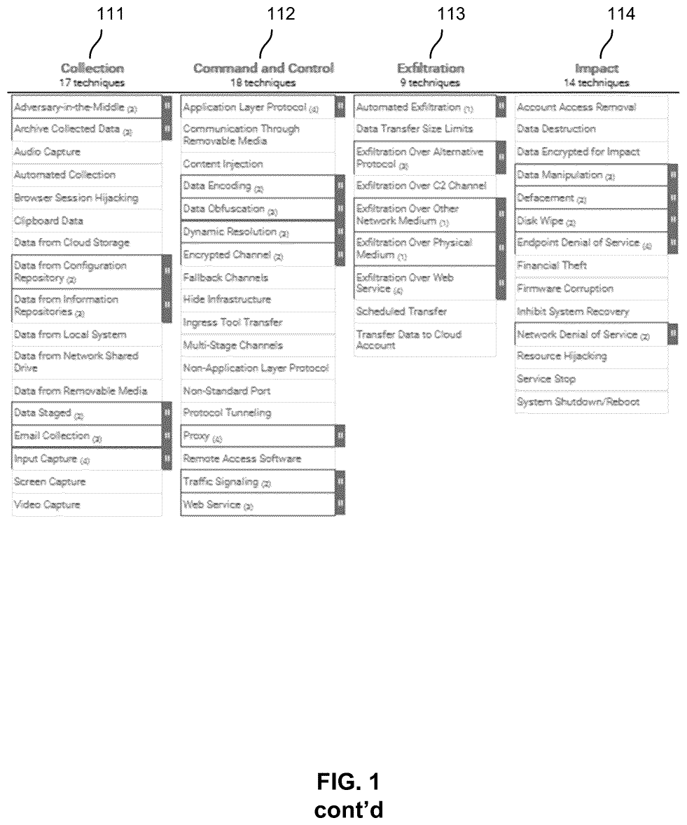

FIG. 1 is diagram illustrating the tactics and associated techniques of the MITRE ATT&CK Framework.

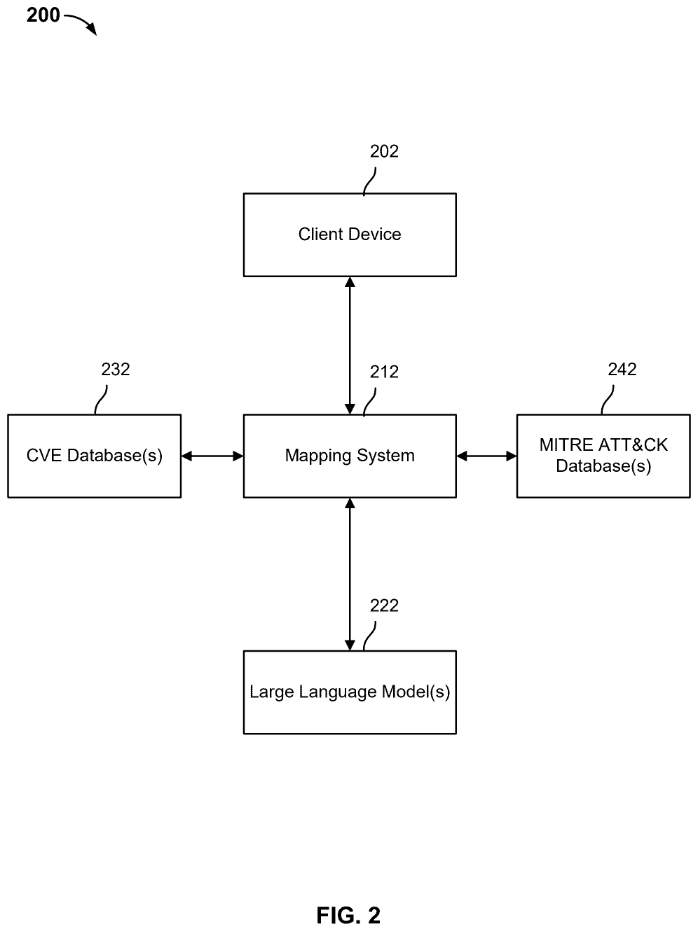

FIG. 2 is a block diagram illustrating a system to map a CVE to one or more tactics associated with the MITRE ATT&CK framework in accordance with some embodiments.

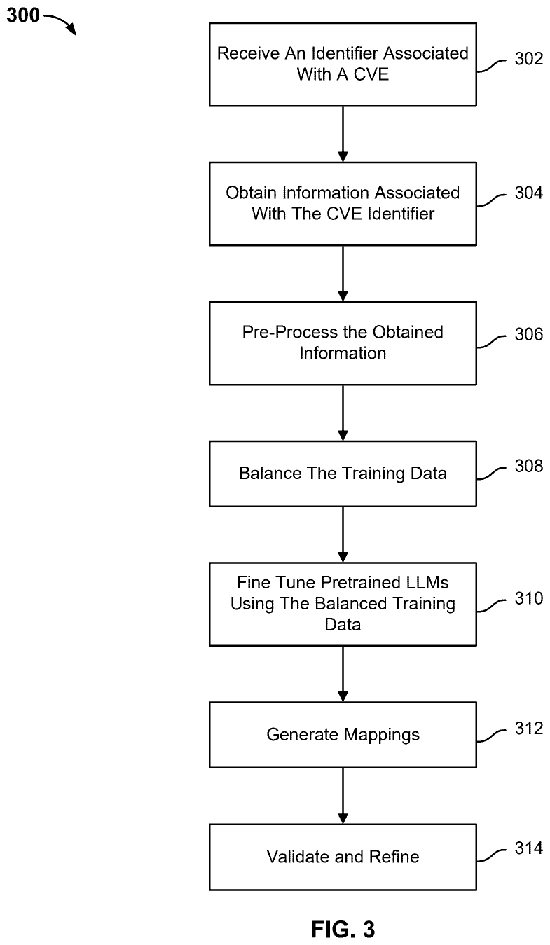

FIG. 3 is a flow diagram illustrating a process of training a system to map a CVE to one or more tactics associated with the MITRE ATT&CK framework in accordance with some embodiments.

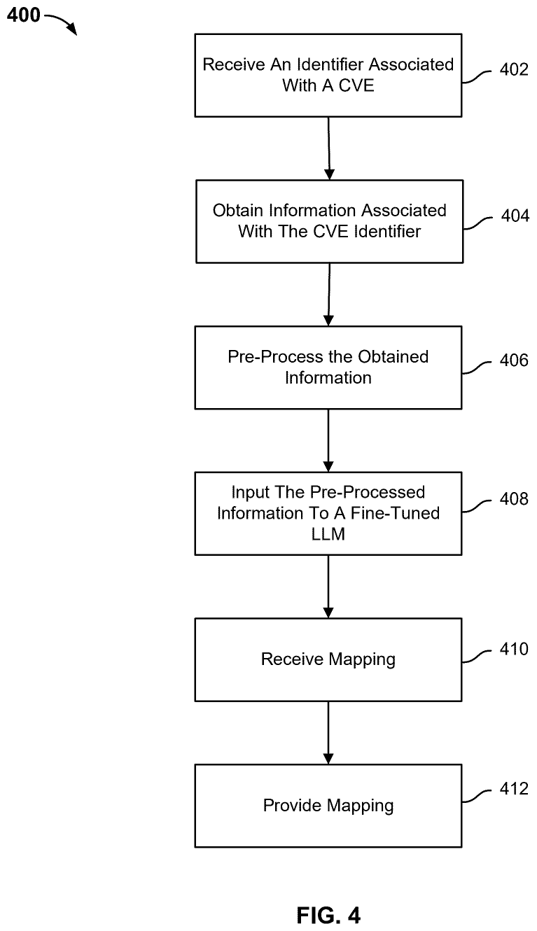

FIG. 4 is a flow diagram illustrating a process of mapping a CVE to one or more tactics associated with the MITRE ATT&CK Framework in accordance with some embodiments.

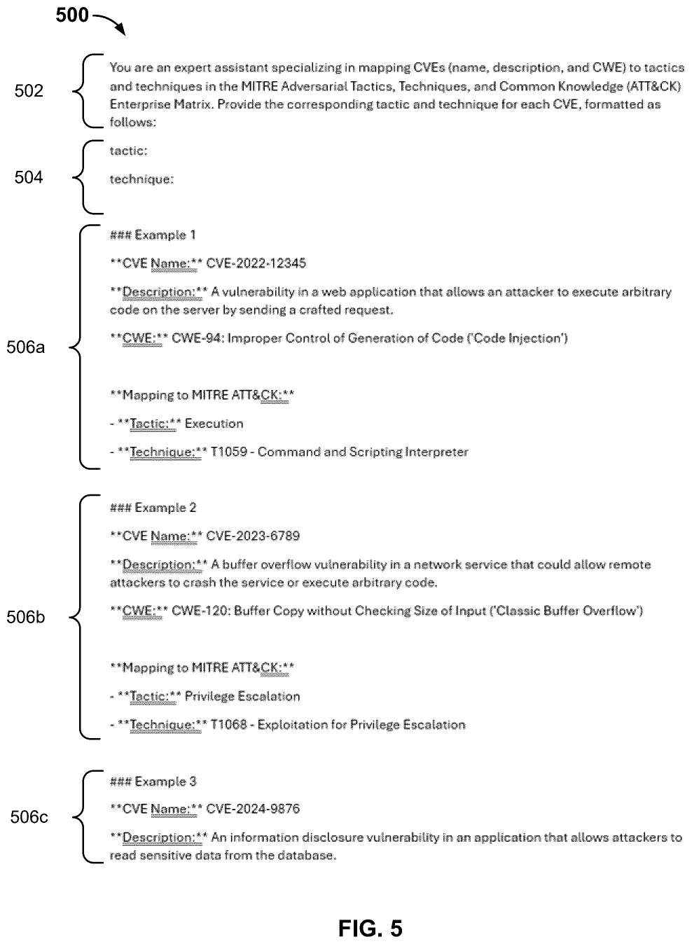

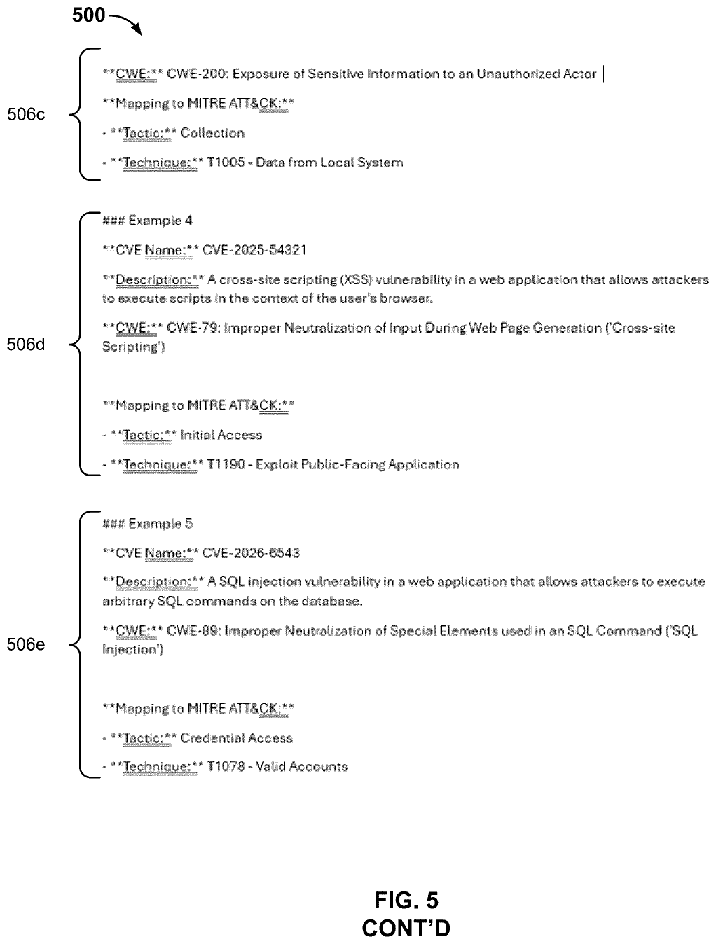

FIG. 5 is an example of a large language model prompt in accordance with some embodiments.

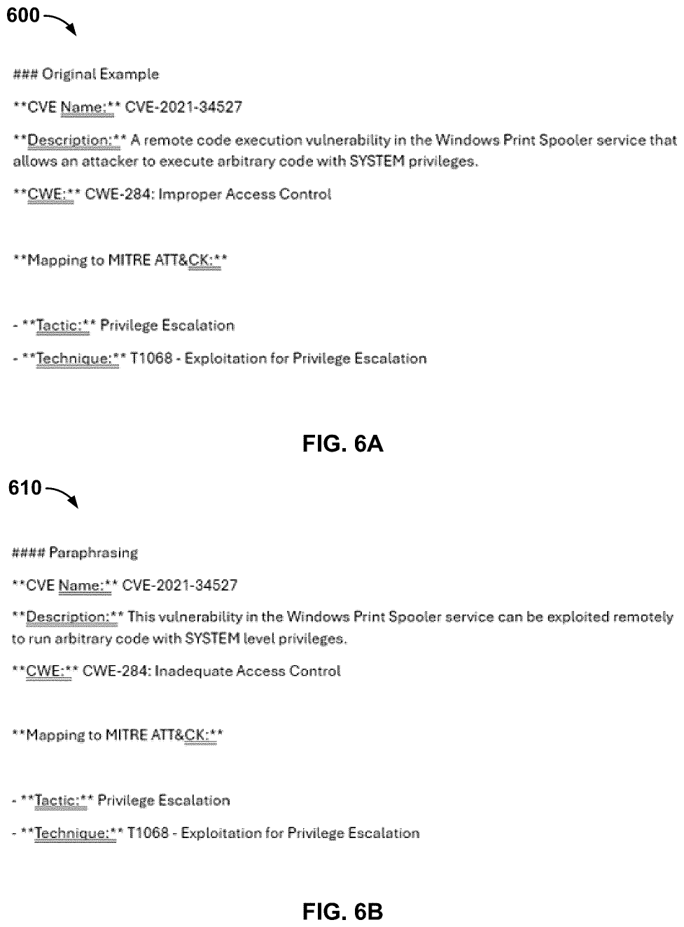

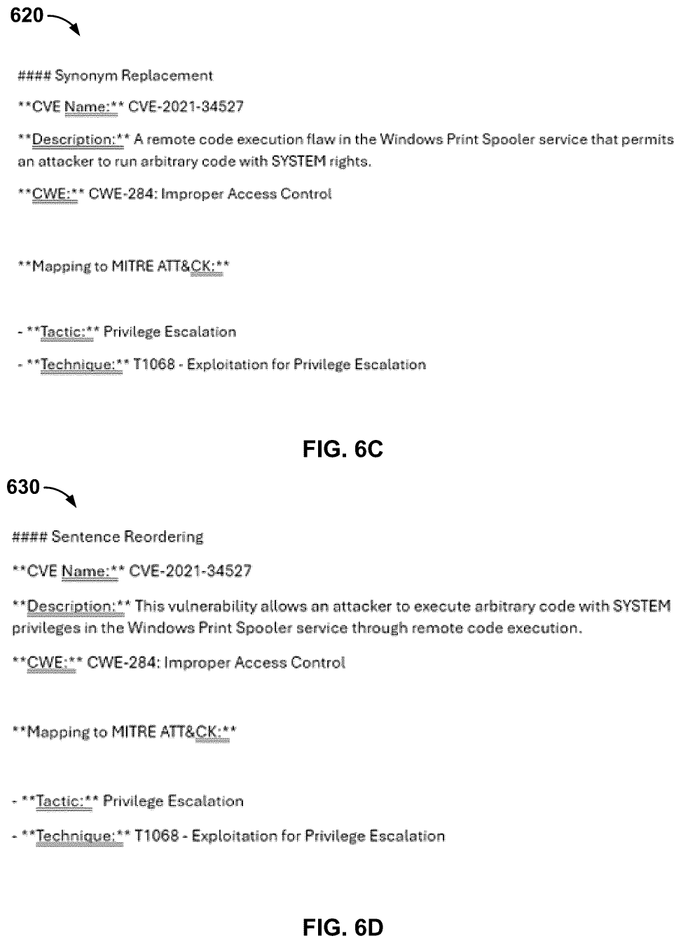

FIG. 6A is an example of an entry used to train a large language model in accordance with some embodiments.

FIG. 6B is an example of a paraphrased entry used to train a large language model in accordance with some embodiments.

FIG. 6C is an example of a synonym replacement entry used to train a large language model in accordance with some embodiments.

FIG. 6D is an example of a sentence reordering entry used to train a large language model in accordance with some embodiments.

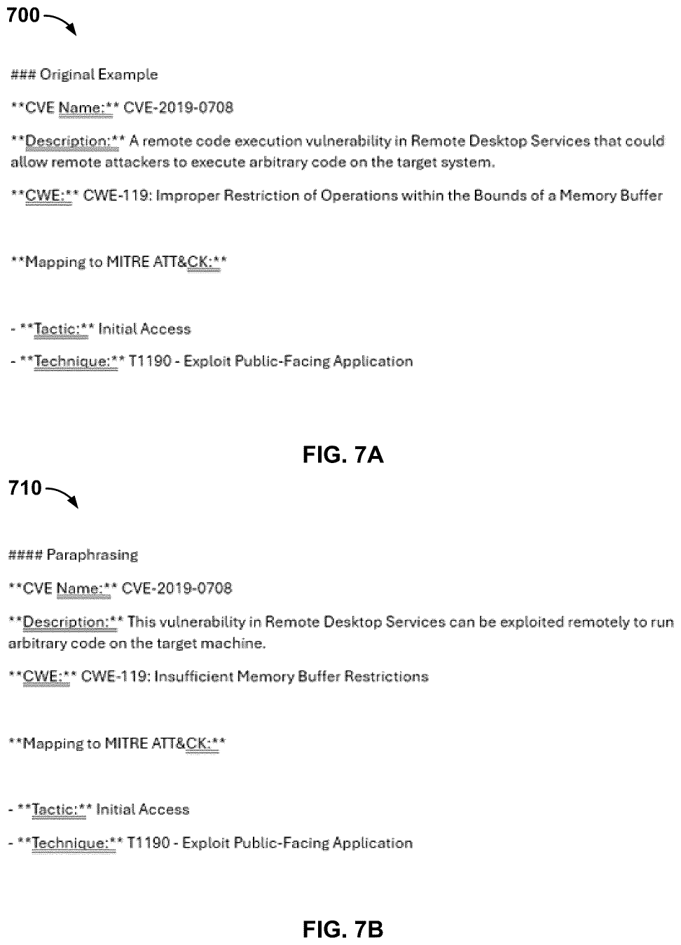

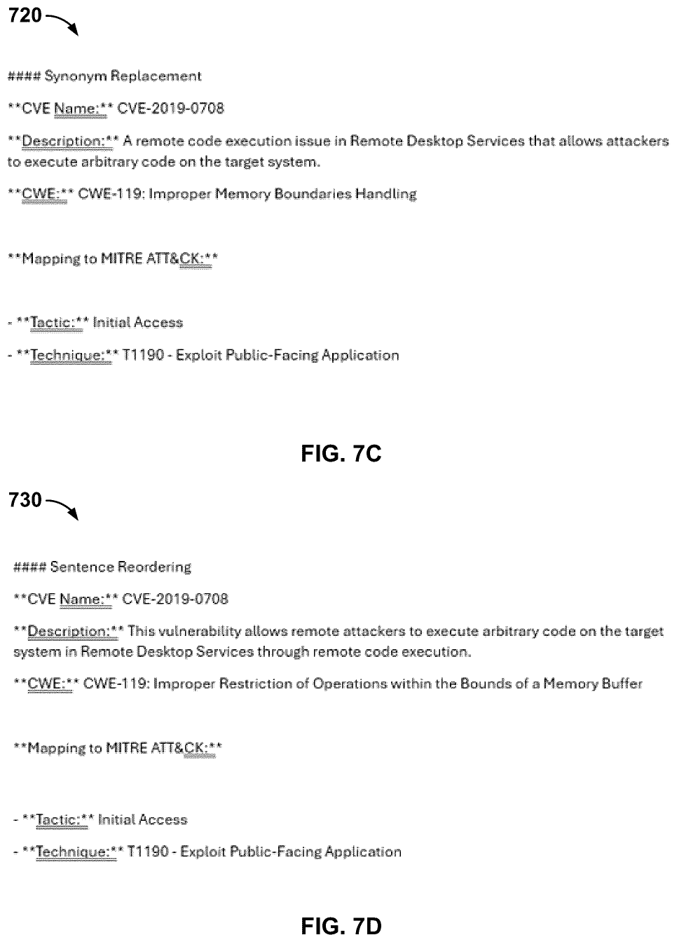

FIG. 7A is an example of an entry used to train a large language model in accordance with some embodiments.

FIG. 7B is an example of a paraphrased entry used to train a large language model in accordance with some embodiments.

FIG. 7C is an example of a synonym replacement entry used to train a large language model in accordance with some embodiments.

FIG. 7D is an example of a sentence reordering entry used to train a large language model in accordance with some embodiments.

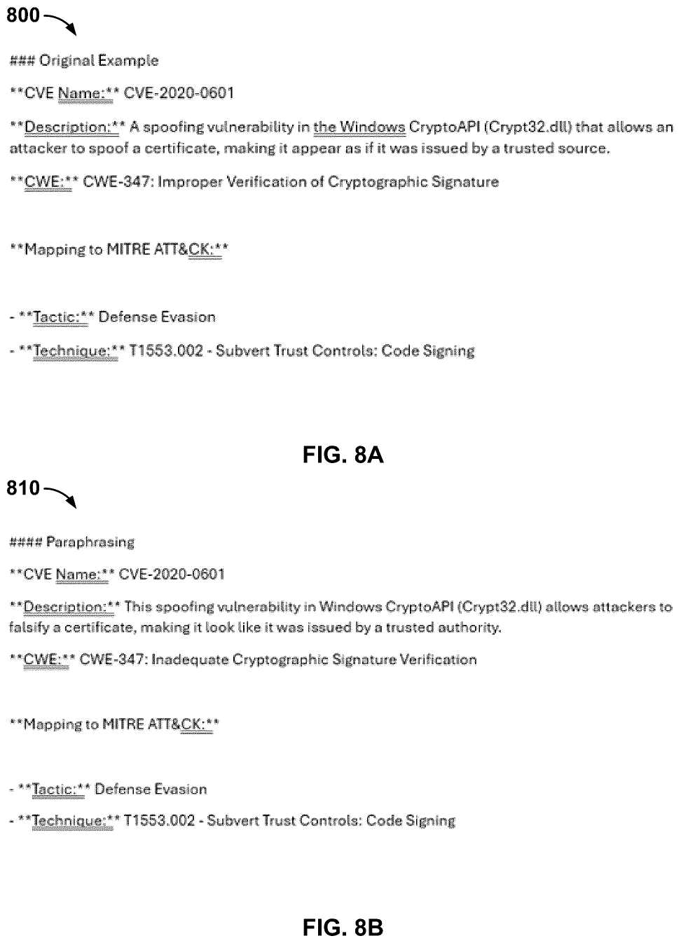

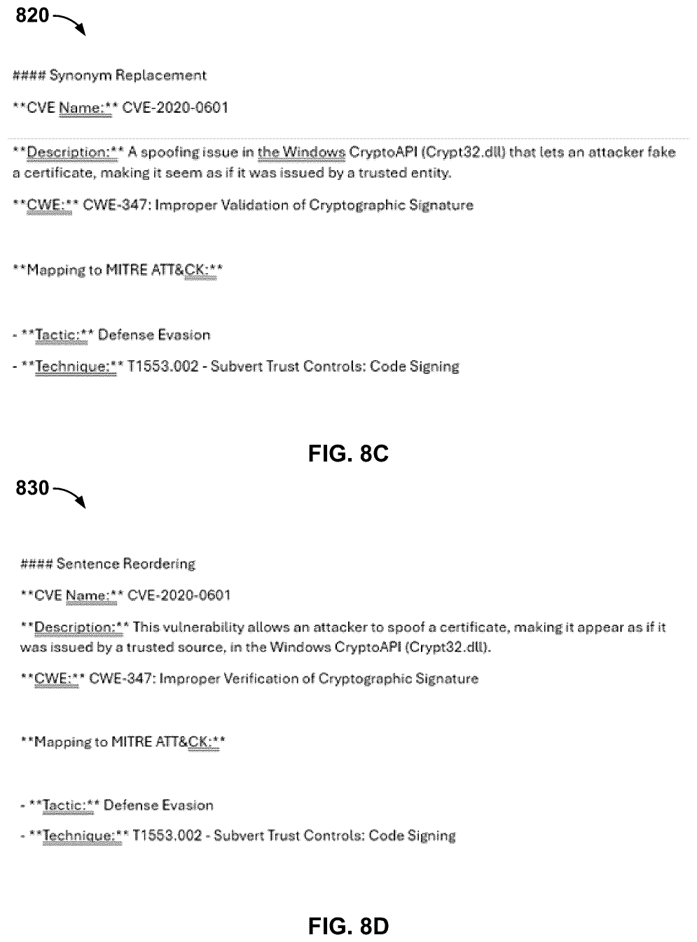

FIG. 8A is an example of an entry used to train a large language model in accordance with some embodiments.

FIG. 8B is an example of a paraphrased entry used to train a large language model in accordance with some embodiments.

FIG. 8C is an example of a synonym replacement entry used to train a large language model in accordance with some embodiments.

FIG. 8D is an example of a sentence reordering entry used to train a large language model in accordance with some embodiments.

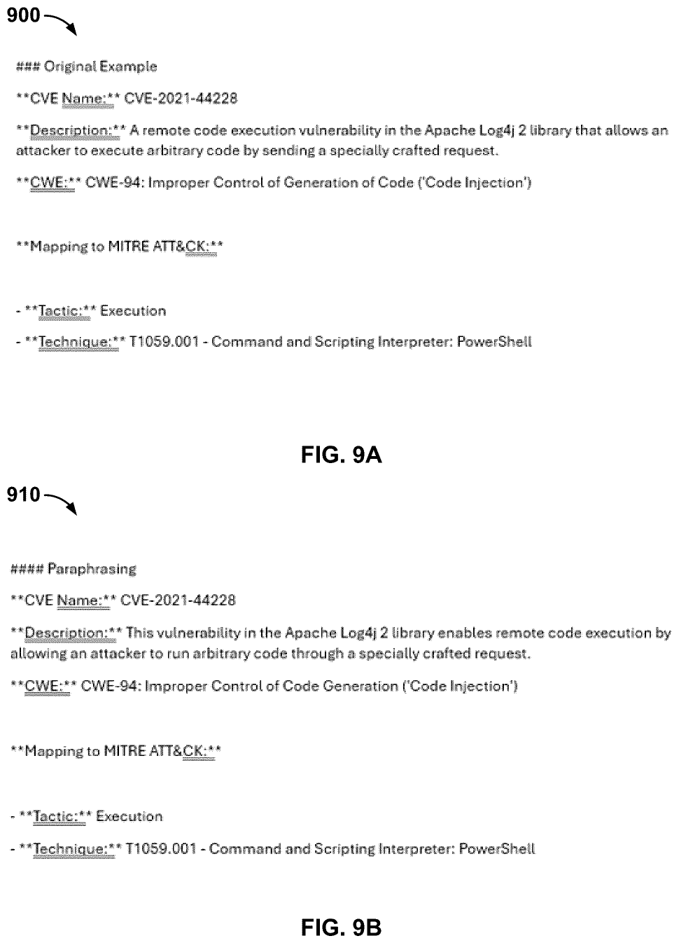

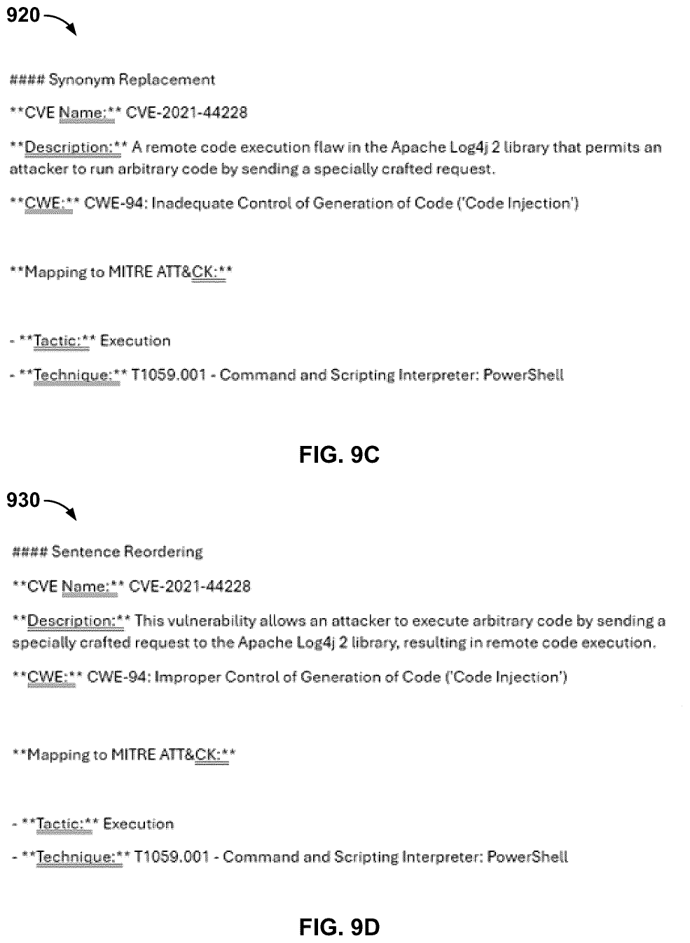

FIG. 9A is an example of an entry used to train a large language model in accordance with some embodiments.

FIG. 9B is an example of a paraphrased entry used to train a large language model in accordance with some embodiments.

FIG. 9C is an example of a synonym replacement entry used to train a large language model in accordance with some embodiments.

FIG. 9D is an example of a sentence reordering entry used to train a large language model in accordance with some embodiments.

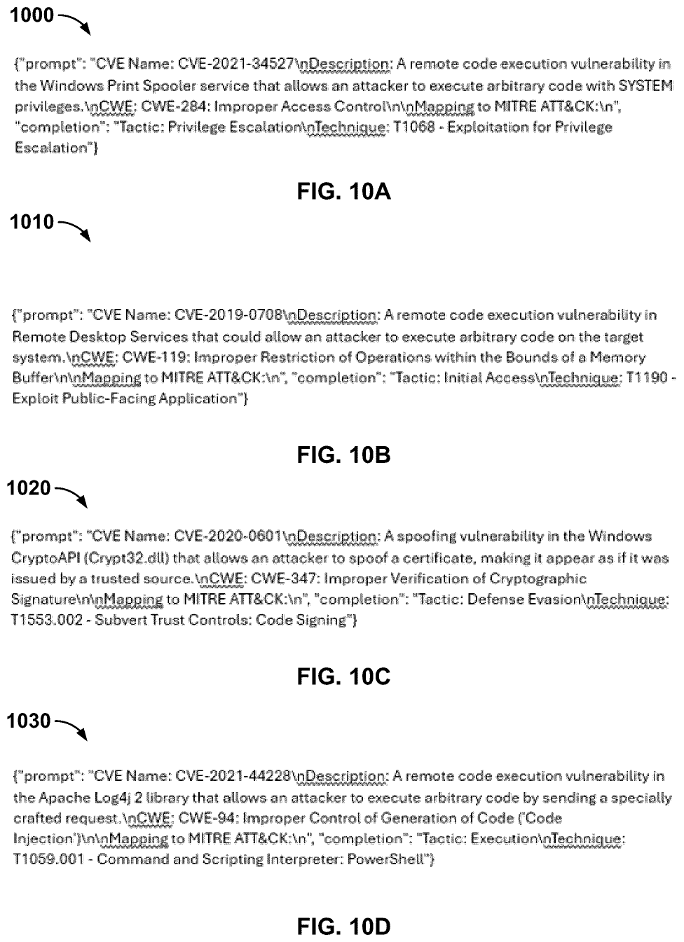

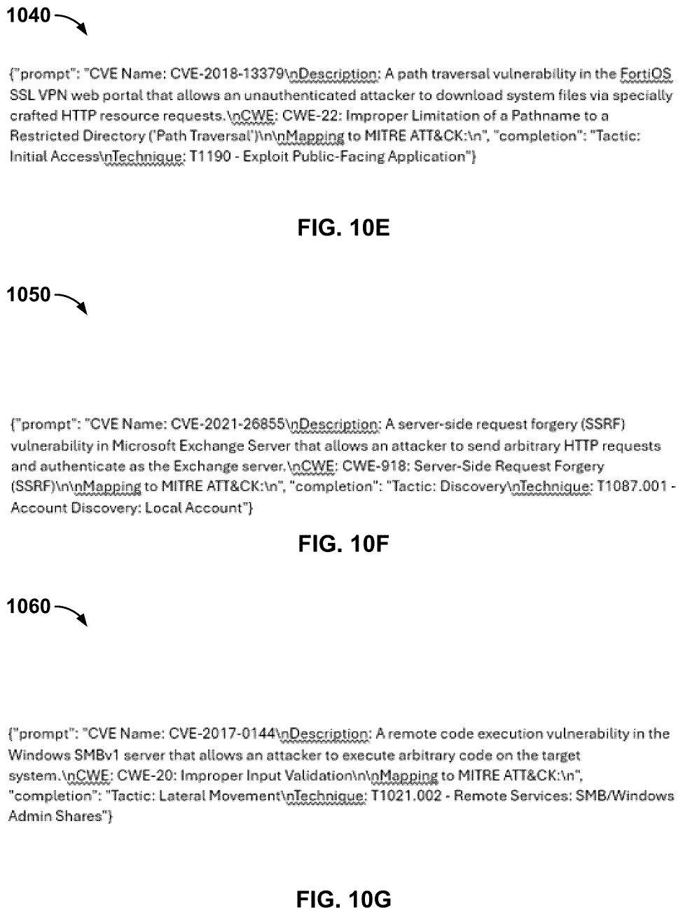

FIGS. 10A-10G are examples of prompts to fine-tune one or more pre-trained LLMs in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system and method to map a CVE to one or more tactics associated with the MITRE ATT&CK Framework are disclosed herein. Mapping between a CVE system and the MITRE ATT&CK Framework can be challenging and time-consuming, as it requires manual effort and expertise in understanding the relationship between specific CVEs and their corresponding MITRE ATT&CK tactics. This may take several hours or even days to perform, leaving a system or application vulnerable to a security threat before the one or more relevant tactics and one or more corresponding techniques of the MITRE ATT&CK Framework are identified. Remediation measures, such as applying a security patch or isolating a component, cannot be implemented until the one or more relevant tactics and the one or more corresponding techniques are identified.

FIG. 1 is diagram illustrating the tactics and associated techniques of the MITRE ATT&CK Framework. In the example shown, the framework 100 includes a first tactic 101, a second tactic 102, a third tactic 103, a fourth tactic 104, a fifth tactic 105, a sixth tactic 106, a seventh tactic 107, an eighth tactic 108, a ninth tactic 109, a tenth tactic 110, an eleventh tactic 111, a twelfth tactic 112, a thirteenth tactic 113, and a fourteenth tactic 114. Although framework 100 depicts 14 different tactics, framework 100 may be expanded to include n tactics.

Each tactic represents a different stage of a cyberattack. In some embodiments, a cyberattack uses one of the tactics 101-114. In some embodiments, a cyberattack uses a plurality of the tactics 101-114. A technique describes how a malicious actor accomplishes a goal. For example, within third tactic 103 of “Initial Access,” the malicious actor may deploy a “Phishing,” “Drive-by-Compromise,” or “Exploit Public-Facing Application” technique.

Each of the tactics 101-114 is associated with a corresponding set of techniques. A set of techniques may include one or more techniques. In some embodiments, a technique is associated with one or more sub-techniques. Sub-techniques allow for a deeper understanding of the specific actions within a technique. For example, within the Phishing technique, sub-techniques might include “Spearphishing Attachment,” “Spearphishing Link,” and “Spearphishing via Service.”

FIG. 2 is a block diagram illustrating a system to map a CVE to one or more tactics associated with the MITRE ATT&CK framework in accordance with some embodiments. In the example shown, mapping system 212 is configured to fine-tune one or more pre-trained large language models 222. Mapping system 212 may be implemented on one or more servers, one or more computers, one or more virtual machines hosted on one or more servers, one or more containers hosted on one or more servers, etc. Examples of a pre-trained LLM 222 include, but are not limited to: GPT 3.5, GPT 4, Meta Llama, Perplexity, Gemini, etc. The one or more pre-trained LLMs 222 are trained using a public set of CVEs that are mapped to certain tactics in the MITRE ATT&CK Framework. This training dataset is imbalanced because the mapping may be heavily skewed towards certain tactics and not have examples for other tactics.

Mapping system 212 is configured to receive a plurality of CVEs from one or more public CVE databases 232. Mapping system 212 is configured to receive CVE-MITRE ATT&CK tactic mappings from one or more public MITRE ATT&CK databases 242.

Mapping system 212 is configured to pre-process the obtained information. Pre-processing the obtained information may include extracting from a CVE information, such as a CVE name, a vulnerability description, a common weakness enumerator (CWE) number, and associated tactics. The CWE is list of common software and hardware weaknesses. The CVE information may indicate which CWE number is associated with the CVE (e.g., CWE-77, CWE-20).

The one or more pre-trained LLMs were trained using the plurality of CVEs from the one or more public CVE databases 232 and the CVE-MITRE ATT&CK tactic mappings from the one or more public MITRE ATT&CK databases 242.

The training dataset used to train the one or more pre-trained LLMs 222 may be balanced by performing data augmentation. Data augmentation is performed by generating additional examples of underrepresented classes in the training dataset. This helps increase the representation of underrepresented classes (tactics, techniques, sub-techniques) in the training dataset and provides the pre-trained LLM with more diverse examples from which to learn. Additional training example(s) may be generated by applying various text transformation techniques, such as paraphrasing, synonym replacement, sentence reordering, and/or a combination thereof.

Data augmentation may be performed on one or more of the CVEs obtained from the one or more public CVE databases 232. For example, another training example may be generated by paraphrasing the vulnerability description associated with an existing CVE. Another training example may be generated by performing synonym replacement for words included in the vulnerability description associated with an existing CVE. Another training example may be generated by re-ordering the sentences included in the vulnerability description associated with an existing CVE.

Mapping system 212 is further configured to balance the training dataset by resampling. Resampling the training dataset may be balanced by oversampling, undersampling, or a combination of both.

Mapping system 212 is configured to fine-tune the one or more pre-trained LLMs 222 by providing one or more prompts to the one or more pre-trained LLMs 222. The prompt may indicate a CVE name, a corresponding description associated with the CVE name, a corresponding CWE associated with the CVE name, a corresponding tactic associated with the CVE name, and a corresponding technique associated with the CVE name.

FIGS. 10A-10G depict examples of prompts 1000, 1010, 1020, 1030, 1040, 1050, 1060, respectively, that may be used to fine-tune one or more pre-trained LLMs.

The one or more pre-trained LLMs 222 subsequently become one or more fine-tuned LLMs. The one or more fine-tuned LLMs are utilized to generate mappings between CVEs and MITRE ATT&CK tactics by inputting vulnerability descriptions and allowing the one or more fine-tuned LLMs to generate relevant tactics based on its understanding of the relationships between the two systems.

Client device 202 is configured to provide mapping system 212 with an identifier associated with a CVE. Client device 202 may be a server, a computer, a desktop, a laptop, a tablet, a smartphone, etc. In response to receiving the CVE, mapping system 212 is configured to obtain information associated with the CVE identifier, pre-process the obtained information, and provide the CVE identifier and the pre-processed information to the one or more fine-tuned LLMs, which generate a response based on the provided CVE identifier and pre-processed information. The obtained information associated with the CVE identifier may include a name associated with the CVE identifier, a description associated with the CVE identifier, a common weakness enumerator (CWE) associated with the CVE identifier, etc. Mapping system 212 is configured to receive the response from the one or more fine-tuned LLMs and provide the response to client device 202.

FIG. 3 is a flow diagram illustrating a process of training a system to map a CVE to one or more tactics associated with the MITRE ATT&CK framework in accordance with some embodiments. In the example shown, process 300 may be implemented by a mapping system, such as mapping system 112.

At 302, an identifier associated with a CVE is received.

At 304, information associated with the CVE identifier is obtained. The information associated with the CVE is obtained from one or more publicly available sources (e.g., the Internet, public databases, etc.).

At 306, the obtained information is pre-processed. Pre-processing the obtained information may include extracting from the obtained information, information such as a CVE name, a vulnerability description, a CWE, and associated tactics.

At 308, a training dataset used to train a pre-trained large language model is balanced. Examples of a pre-trained large language model include, but are not limited to: GPT 3.5, GPT 4, Meta Llama, Perplexity, Gemini, etc. The pre-trained large language model is trained using a public set of CVEs that are mapped to certain tactics in the MITRE ATT&CK Framework. This training dataset is imbalanced because the mapping may be heavily skewed towards certain tactics and not have examples for other tactics. For instance, the training dataset may include many CVEs that map to an initial access tactic, but not many examples of CVEs that map to a lateral movement tactic or a command and control tactic. As a result, the pre-training LLM is unlikely to map a CVE to a tactic for which there were not many examples used to train the pre-trained LLM. As a result, the pre-trained may be unable to correctly identify a stage at which a security vulnerability exists. For example, the training dataset may map 97% of the CVEs to a first tactic and 3% of the CVEs to a second tactic. The pre-trained LLM is more likely to map a new CVE to the first tactic than it is to map a new CVE to the second tactic. The new security vulnerability may actually attack a system or application using the second tactic. The system or application is open to a cyberattack until the new CVE is correctly mapped to the second tactic. The training dataset may include some or all of the information associated with the CVE obtained at 304.

Each tactic is associated with a plurality of techniques. The training dataset may include several examples of a tactic, but not include examples of all techniques associated with the tactic. As a result, the pre-training LLM is unlikely to map a CVE to a technique that is not associated with one of the examples with which the pre-trained LLM was trained.

The training dataset may be balanced by performing data augmentation. Data augmentation is performed by generating additional examples of underrepresented classes in the training dataset. This helps increase the representation of underrepresented classes (tactics, techniques, sub-techniques) in the training dataset and provides the pre-trained LLM with more diverse examples from which to learn. Additional training example(s) may be generated by applying various text transformation techniques, such as paraphrasing, synonym replacement, sentence reordering, and/or a combination thereof. For example, an existing entry corresponding to an underrepresented class may be become ten entries using the disclosed techniques. FIGS. 6A, 7A, 8A, and 9A depict examples of entries 600, 700, 800, 900, respectively, used to train an LLM. The entries 600, 700, 800, 900 provide a corresponding CVE name, a corresponding description associated with the CVE, a corresponding CWE associated with the CVE, a corresponding tactic associated with the CVE, and a corresponding technique associated with the CVE.

Paraphrasing may include summarizing or rephrasing the vulnerability description associated with an existing entry and/or the CWE description associated with the existing entry. Synonym replacement may include replacing one or more words included in the vulnerability description associated with an existing entry and/or a CWE description associated with an existing entry to one or more synonyms. Sentence reordering may include changing the order in which a plurality of sentences in the vulnerability description appear in the vulnerability description. FIGS. 6B, 7B, 8B, and 9B depict examples of paraphrased entries 610, 710, 810, 910, respectively, used to train an LLM. The paraphrased entries 610, 710, 810, 910 may summarize or rephrase the corresponding description included in entries 600, 700, 800, 900, respectively, and/or the corresponding CWE included in entries 600, 700, 800, 900, respectively.

FIGS. 6C, 7C, 8C, and 9C depict examples of synonym replacement entries 620, 720, 820, 920, respectively, used to train an LLM. The synonym replacement entries 620, 720, 820, 920 may replace one or more words with a corresponding synonym in the corresponding description included in entries 600, 700, 800, 900, respectively, and/or the corresponding CWE included in entries 600, 700, 800, 900, respectively.

FIGS. 6D, 7D, 8D, and 9D depict examples of sentence reordering entries 620, 720, 820, 920, respectively, used to train an LLM. The sentence reordering entries 620, 720, 820, 920 may change the order of the sentences included in the corresponding description included in entries 600, 700, 800, 900, respectively.

The training dataset may be further balanced by resampling. Resampling the training dataset may be balanced by oversampling, undersampling, or a combination of both. Oversampling involves creating copies of existing entries from an underrepresented class, which undersampling includes removing instances of an overrepresented class (tactics, techniques, sub-techniques). In some embodiments, resampling methods, such as Synthetic Minority Oversampling Technique (SMOTE) or Adaptive Synthetic Sampling (ADASYN) is used to create synthetic examples of underrepresented classes.

At 310, the pre-trained LLM is fine-tuned using the balanced training data. The pre-trained LLM is given a prompt and a context window.

The prompt provides guardrails for the pre-trained LLM. For example, the prompt may inform that pre-trained LLM: “you are an expert of cyber security and you have good knowledge above CVE and MITRE ATT&CK framework. When I provide you with CVE information, you can give me the corresponding MITRE attack stage the CVE belongs to.” The prompt may also indicate the expected response and format for the expected response.

The balanced training dataset is provided to the pre-trained LLM as the context window.

At 312, mappings are generated. The fine-tuned LLM is utilized to generate mappings between CVEs and MITRE ATT&CK tactics by inputting vulnerability descriptions and allowing the model to generate relevant tactics based on its understanding of the relationships between the two systems.

Automating the process of mapping between CVEs and MITRE ATT&CK tactics reduces the time and effort required by cybersecurity processionals, leading to cost savings and increased efficiency. The LLM-based mapping solution can easily scaled to accommodate the growing number of CVES and tactics in the MITRE ATT&CK framework, ensuring that organizations stay up-to-date with the latest threat information. The LLM-based mapping solution can be easily integrated into existing cybersecurity tools, systems, or processes and can be customized to meet the specific needs of an organization, providing a flexible and adaptable solution for mapping between CVE and MITRE ATT&CK frameworks.

At 314, the generated mappings are validated and the fine-tuned LLM is refined. The generated mappings are validated using expert knowledge and available resources. The model is refined as needed to improve the accuracy and relevance of the mappings using the expert knowledge and available resources.

As new vulnerabilities and tactics emerge, the LLM-based solution can be fine-tuned and updated to maintain its effectiveness and accuracy, ensuring that the mappings remain relevant and useful.

FIG. 4 is a flow diagram illustrating a process of mapping a CVE to one or more tactics associated with the MITRE ATT&CK Framework in accordance with some embodiments. In the example shown, process 400 may be implemented by a mapping system, such as mapping system 412.

At 402, an identifier associated with a CVE is received.

At 404, information associated with the CVE identifier is obtained. The information associated with the CVE is obtained from one or more publicly available sources (e.g., the Internet, public databases, etc.).

At 406, the obtained information is pre-processed. Pre-processing the obtained information may include extracting from the obtained information, information such as a CVE name, a vulnerability description, a CWE, and associated tactics.

At 408, the pre-processed information is inputted to a fine-tuned LLM trained to map the CVE to one or more tactics associated with the MITRE ATT&CK Framework.

At 406, a mapping of the new CVE to one or more corresponding attack tactics associated with the CVE identifier is received.

At 408, the mapping is provided to the client device.

By providing an automated way to map between CVEs and MITRE ATT&CK tactics, organizations can gain a deeper understanding of the threats they face, enabling them to take more informed and proactive steps to protect their systems.

FIG. 5 is an example of a large language model prompt in accordance with some embodiments. In the example shown, prompt 500 includes a role 502 for the large language model, a desired format of the response 504, and context examples 506a, 506b, 506c, 506d, 506e.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
obtaining a plurality of Common Vulnerabilities and Exposures (CVEs);
pre-processing the CVEs in part by extracting information from the plurality of CVEs to generate a training dataset;
fine-tuning one or more pre-trained large language models (LLMS) using a balanced version of the training dataset;
automatically generating a mapping of the plurality of CVEs to one or more attack tactics utilizing the one or more fine-tuned LLMs by inputting into the one or more fine-tuned LLMS vulnerability descriptions associated with the plurality of CVEs.

2. The method of claim 1, wherein the plurality of CVEs are obtained from one or more publicly available sources.

3. The method of claim 1, wherein the plurality of CVEs obtained from the one or more publicly available sources include a mapping between the plurality of CVEs and a corresponding set of one or more attack tactics.

4. The method of claim 1, wherein the extracted information from a CVE of the plurality of CVEs includes a corresponding name, a vulnerability description, a common weakness enumerator, and/or one or more corresponding tactics associated with the CVE.

5. The method of claim 1, further comprising balancing the training dataset to become the balanced version of the training dataset.

6. The method of claim 5, wherein balancing the training dataset includes performing data augmentation on one or more entries of the training dataset.

7. The method of claim 6, wherein performing data augmentation on the one or more entries of the training dataset includes paraphrasing a vulnerability description associated with at least one of the one or more entries to generate a new entry to be included in the training dataset.

8. The method of claim 6, wherein performing data augmentation on the one or more entries of the training dataset includes performing synonym replacement for one or more words included in a vulnerability description associated with at least one of the one or more entries to generate a new entry to be included in the training dataset.

9. The method of claim 6, wherein performing data augmentation on the one or more entries of the training dataset includes performing sentence reordering for one or more sentences included in a vulnerability description associated with at least one of the one or more entries to generate a new entry to be included in the training dataset.

10. The method of claim 6, wherein performing data augmentation on the one or more entries of the training dataset includes performing a combination of paraphrasing, synonym replacement, and sentence reordering for at least one of the one or more entries to generate a new entry to be included in the training dataset.

11. The method of claim 5, wherein balancing the training dataset includes resampling the training dataset.

12. The method of claim 11, wherein resampling the training dataset includes oversampling existing entries in the training dataset.

13. The method of claim 11, wherein resampling the training dataset includes under sampling existing entries in the training dataset.

14. The method of claim 11, wherein resampling the training dataset includes a combination of oversampling existing entries in the training dataset and under sampling the existing entries in the training dataset.

15. The method of claim 1, further comprising:
receiving a new CVE;
providing a vulnerability description associated with the new CVE to the one or more fine-tuned LLMs; and
receiving a mapping of the new CVE to one or more corresponding attack tactics associated with the new CVE.

16. A system, comprising:
a processor configured to:
obtain a plurality of Common Vulnerabilities and Exposures (CVEs);
pre-process the CVEs in part by extracting information from the plurality of CVEs to generate a training dataset;
fine-tune one or more pre-trained large language models (LLMS) using a balanced version of the training dataset;
automatically generate a mapping of the plurality of CVEs to one or more attack tactics utilizing the one or more fine-tuned LLMs by inputting into the one or more fine-tuned LLMS vulnerability descriptions associated with the plurality of CVEs; and
a memory coupled to the processor and configured to provide the processor with instructions.

17. The system of claim 16, wherein the processor is further configured to balance the training dataset to become the balanced version of the training dataset.

18. The system of claim 17, wherein to balance the training dataset, the processor is configured to perform data augmentation on one or more entries of the training dataset.

19. The system of claim 17, wherein to balance the training dataset, the processor is configured to resample the training dataset.

20. A computer program product embodied in a non-transitory computer readable medium and comprising computer instructions for:
obtaining a plurality of Common Vulnerabilities and Exposures (CVEs);
pre-processing the CVEs in part by extracting information from the plurality of CVEs to generate a training dataset;
fine-tuning one or more pre-trained large language models (LLMS) using a balanced version of the training dataset;
automatically generating a mapping of the plurality of CVEs to one or more attack tactics utilizing the one or more fine-tuned LLMs by inputting into the one or more fine-tuned LLMS vulnerability descriptions associated with the plurality of CVEs.
